(19) United States
(12) Patent Application Publication
(10) Pub. No.: US 2005/0202991 A1
(43) Pub. Date: Sep. 15, 2005

(54) Bactericide surfactant compositions

(75) Inventors: Mattia De Dominicis, San Martino di Lupari (IT); Zefferino Righetto, Camponogara (IT)

Correspondence Address: NORRIS, MCLAUGHLIN & MARCUS, 875 THIRD AVE, 18TH FLOOR, NEW YORK, NY, 10022, US

(73) Assignee: Reckitt Benckiser N.V., Hoofddorp (NL)

(21) Appl. No.: 10/524,085

(22) PCT Filed: Aug. 7, 2003
(86) PCT No.: PCT/GB03/03447

§ 371 Date: Apr. 15, 2005

(30) Foreign Application Priority Data
Aug. 14, 2002 (GB) 0218857.1

(51) Int. Cl. C11D 1/00

(52) U.S. Cl. 510/383; 510/504

(57) ABSTRACT

A detergent comprising: a) 0.001% to 40% w/v of a bactericidally active water-insoluble cationic compound in its salt form wherein the counterion anion has at least one of the following properties: 1) can generate a water-insoluble salt form, by water-insoluble we mean that less than 10% w/v dissolves in deionised water at 20° C., preferably less than 1% w/v; 2) has a MW of less than 300, (preferably less than 200) but greater than 50 (preferably greater than 75), 3) the dissociation constant (Kd) of the salt is less than 10⁻³, preferably less than 10⁻⁶; b) 0.001 to 40% w/v of an anionic surfactant; and c) up to 98% w/v of water.

The invention relates to anionic surfactant compositions containing a bactericide, which is a cationic compound, being specifically developed for fabric cleaning products.

In general, cationic bactericide compounds have low compatibility with anionic based surfactant compositions and they may have a negative effect in terms of the cleaning performance of the composition.

Certain cationic compounds, as described below, are well known actives able to provide good disinfecting efficacy both versus gram negative and gram positive bacteria, but have in general low compatible with anionic surfactants or anionic species in general. Cationic compounds tend to precipitate with anionic compounds or lose their bactericide efficacy due to the formation of an anionic-cationic complex that doesn't allow the cationic part of the complex to be available to kill bacteria. The cationic compounds are, in addition, well known to cause stickiness to fabric surfaces, especially carpet, and are very deleterious for soil re-deposition, which is considered an important factor for fabric care. Generally cationic compounds are metal corrosives making their use in aerosols problematical.

Phenols and phenol based bactericides are other ingredients used in several application areas. More and more concerns about their toxicological impact is growing, they are considered as potential carcinogens and they are generally avoided for this reason.

Aldehydes such as formaldehyde and glutaraldehyde are cheap and broad-spectrum bactericides, but as with phenols, they are carcinogens or potential carcinogens and also show a tendency to sensitise people who are frequently exposed to them.

The halogens have a long history as bactericide agents. Chloride is the active atom in household bleach and chloride and bromine are used for water disinfection. Iodine is very commonly incorporated into antiseptics, for disinfecting skin and wound dressings, and it is added to water for water treatment. Iodine used as such or in combination with organic carrier molecules, iodophors, is used as a liquid disinfectant, but it tends to stains the treated surface with reddish-brown colour. Chlorine is cheap and very effective, but it tends to corrode metal surface and to decolourise dyes from the fabric surface.

Organic acids are known in the art to be bactericides, examples are citric acid and salicylic acid. The organic acids are efficient at low pH, below 5 and more preferably below 4. At these low pH conditions the cleaning performances of the surfactants are reduced and the compositions work mainly as a bactericide not as a good cleaning product.

Alcohols, such as iso-propanol and ethanol, have been used for a long time in ready to use disinfectants for medical and consumer products. To be effective they need to make up a significant percentage of the composition, usually 15-70% w/v, the disadvantages are that, being a solvent, they attack many polymers and plastics and cause the composition to be high flammable.

Other known ingredients are the essential oils, such as tea tree oil, thyme oil and citronella oil. These products show a low/medium bacteria efficacy, unless used at high concentration, but at high concentrations they may become sensitisers.

In the present invention we have surprisingly found that certain cationic compounds, as described below, are compatible with anionic surfactants and anionic based products and maintain their bactericidal activity, having a low toxicological impact and low or no negative effects on the composition in terms of cleaning, soil re-deposition and fibre damage.

Whilst not wishing to be bound by theory we believe that “large” counterion anions sterically hinder complex formulation with other anionic species in the composition.

The cationic compounds of the invention are those that provide a germicidal effect to the concentrate compositions, and especially preferred are quaternary ammonium salts which may be characterised by the general structural formula: 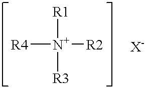
wherein R1, R2, R3 and R4 are independently selected from alkyl, aryl or alkylaryl substituent of from 1 to 26 carbon atoms, and the entire cation portion of the molecule has a molecular weight of at least 165. The alkyl substituents may be long-chain alkyl, long-chain alkoxyaryl, long-chain alkylaryl, halogen-substituted long-chain alkylaryl, long-chain alkylphenoxyalkyl and arylalkyl. The remaining substituents on the nitrogen atoms other than the above mentioned alkyl substituents are hydrocarbons usually containing no more than 12 carbon atoms. The substituents R1, R2, R3 and R4 may be straight-chained or may be branched, but are preferably straight-chained, and may include one or more amide, ether or ester linkages.

Preferred cationic compounds of the invention which are useful in the practice of the present invention include those which have the structural formula: 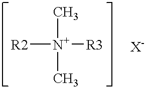
wherein R2 and R3 are each independently the same or different C₈-C₁₂ alkyl; or R2 is selected from C12-16 alkyl, C8-18 alkylethoxy or C8-18 alkylphenoxyethoxy and R3 is benzyl. Counterion X⁻ is a salt forming anion as described below. The alkyl groups recited in R2 and R3 may be straight-chained or branched, but are preferably substantially linear. Such useful quaternary compounds are available and include ONYXIDE™ 3300 is described as n-alkyl dimethyl benzyl ammonium saccharinate (95% active). ONYXIDE™ 3300 is presently commercially available from Stepan Company, Northfield, Ill.—USA.

Preferably the cationic compound is: 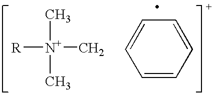
wherein R is a linear or branched alkyl chain having from 1 to 30 carbon atoms, more preferably from 10 to 16 atoms.

In the present invention the nature of the anion counterion X⁻ is important. Preferred counterions X⁻ are those which have at least one preferably two or all three, of the following properties:
1) can generate a water-insoluble salt form, by water-insoluble we mean that less than 10% w/v dissolves in deionised water at 20° C., preferably less than 1% w/v;
2) has a MW of less than 300 (preferably less than 200) but greater than 50 (preferably greater than 75);
3) the dissociation constant (Kd) of the salt is less than 10⁻³, preferably less than 10⁻⁶.

A preferred feature is 2) or 2)+3).

Preferably the counterion X⁻ should have all three above properties. Preferred counterions X⁻ of the invention are selected from saccharinate, alkyl sulfate and alkyl benzene sulfate, alkyl, sulfonate, alkyl benzene sulfonate and fatty acid.

The level of cationic compound used depends upon the product type, whether it is a ready to use product or a dilutable formula. Suitable levels for a ready to use product is 0.001% to 5% w/v, a preferred range is 0.01 to 0.5% w/v. A dilutable product requires more active and a suitable range is from 0.01 to 40% w/v, preferably between 0.5 to 20% depending on the dilution ratio.

It has been surprisingly found that the cationic compound, as defined herein, is compatible with anionic surfactants as well as in general with anionic polymer based products. The compositions containing the cationic compound, anionic surfactant, non ionic surfactants, polymers, solvents, chelating agents, and other minor actives as dyes, antifoaming, perfumes, preservatives, . . . etc, have cleaning performance, low fabric damage, and good prevention of soil re-deposition. It has been found surprisingly that the cationic compound is very effective bactericide even in combination with anionic surfactants.

The cationic compound described in the compositions of this invention can achieve a log5 bacteria reduction at concentrations below 5000 ppm in the final liquid cleaning product, preferably below 1500 ppm. The cationic compounds described in this invention can also be mixed with low quantity of other bactericide compounds in order to increase the bactericidal efficacy without any negative effect in terms of cleaning performance. Examples of these bactericides actives are those previously described as essential oils (tea tree oil, citronella oil and thyme oil), phenols, alcohols, halogens, aldehydes and acids. The level of addition is in this case very low, between 0.001 to 1% w/v, preferably between 0.01 to 0.5% w/v.

Examples of surfactants considered in this invention are either anionic surfactant, non-ionic surfactant and super wetting agents. Preferred levels of surfactant are from 0.01 to 40% w/v, ideally from 0.1 to 10% w/v and preferably 0.5 to 5% w/v. The non-ionic surfactant is preferably is an amount of 0.01 to 30% w/v, ideally, 0.1 to 15% w/v or 0.5 to 10% w/v. The nonionic surfactant preferably has a formula RO(CH2CH2O)ₙH wherein R is a mixture of linear, even carbon-number hydrocarbon chains ranging from C12H25 to C16H33 and n represents the number of repeating units and is a number of from about 1 to about 12. Examples of other non-ionic surfactants include higher aliphatic primary alcohols containing about twelve to about 16 carbon atoms which are condensed with about three to thirteen moles of ethylene oxide.

Other examples of non-ionic surfactants include primary alcohol ethoxylates (available under the Neodol tradename from Shell Co.), such as C11 alkanol condensed with 9 moles of ethylene oxide (Neodol 1-9), C12-13 alkanol condensed with 6.5 moles ethylene oxide (Neodol 23-6.5), C12-13 alkanol with 9 moles of ethylene oxide (Neodol 23-9), C12-15 alkanol condensed with 7 or 3 moles ethylene oxide (Neodol 25-7 or Neodol 25-3), C14-15 alkanol condensed with 13 moles ethylene oxide (Neodol 45-13), C9-11 linear ethoxylated alcohol, averaging 2.5 moles of ethylene oxide per mole of alcohol (Neodol 91-2.5), and the like.

Other examples of non-ionic surfactants suitable for use in the present invention include ethylene oxide condensate products of secondary aliphatic alcohols containing 11 to 18 carbon atoms in a straight or branched chain configuration condensed with 5 to 30 moles of ethylene oxide. Examples of commercially available non-ionic detergents of the foregoing type are C11-15 secondary alkanol condensed with either 9 moles of ethylene oxide (Tergitol 15-S-9) or 12 moles of ethylene oxide (Tergitol 15-S-12) marketed by Union Carbide, a subsidiary of Dow Chemical.

Octylphenoxy polyethoxyethanol type non-ionic surfactants, for example, Triton X-100, as well as amine oxides can also be used as a non-ionic surfactant in the present invention.

Other examples of linear primary alcohol ethoxylates are available under the Tomadol tradename such as, for example, Tomadol 1-7, a C11 linear primary alcohol ethoxylate with 7 moles EO; Tomadol 25-7, a C12-C15 linear primary alcohol ethoxylate with 7 moles EO; Tomadol 45-7, a C14-C15 linear primary alcohol ethoxylate with 7 moles EO; and Tomadol 91-6, a C9-C11 linear alcohol ethoxylate with 6 moles EO.

A preferred surfactant is an anionic surfactant. Such anionic surface active agents are frequently provided in a salt form, such as alkali metal salts, ammonium salts, amine salts, amino alcohol salts or magnesium salts. Contemplated as useful are one or more sulfate or sulfonate compounds including: alkyl sulfates, alkyl ether sulfates, alkylamidoether sulfates, alkyl benzene sulfates, alkyl benzene sulfonates, alkylaryl polyether sulfates, monoglyceride sulfates, alkylsulfonates, alkylamide sulfonates, alkylarylsulfonates, olefinsulfonates, paraffin sulfonates, alkyl sulfosuccinates, alkyl ether sulfosuccinates, alkylamide sulfosuccinates, alkyl sulfosuccinamate, alkyl sulfoacetates, alkyl carboxylates, alkyl phosphates, alkyl ether phosphates, acyl sarconsinates, acyl isethionates, and N-acyl taurates. Generally, the alkyl or acyl radical in these various compounds comprise a carbon chain containing 12 to 20 carbon atoms.

Preferred surfactants are also alkyl naphthalene sulfonate anionic surfactants of the formula: 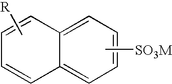
wherein R is a straight chain or branched alkyl chain having from about 1 to about 25 carbon atoms, saturated or unsaturated, and the longest linear portion of the alkyl chain is 15 carbon atoms or less on the average, M is a cation which makes the compound water soluble especially an alkali metal such as sodium or magnesium, ammonium or substituted ammonium cation.

Particularly preferred are alkyl sarcosinate, sulfosuccinate and alkyl sulfate anionic surfactants of the formula 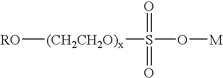
wherein R is a straight chain or branched alkyl chain having from about 8 to about 18 carbon atoms, saturated or unsaturated, and the longest linear portion of the alkyl chain is 15 carbon atoms or less on the average, M is a cation which makes the compound water soluble especially an alkali metal such as sodium or magnesium, ammonium or substituted ammonium cation, and x is from 0 to about 4. Most preferred are the non-ethoxylated C12-15 primary and secondary alkyl sulfates, especially sodium lauryl sulfate.

Most desirably, the anionic surfactant according to constituent is selected to be of a type that dries to a friable powder. This facilitates their removal from carpets and carpet fibres, such as by brushing or vacuuming.

Super wetting agents are used between 0.001 to 10% w/v, preferably from 0.01 to 10% w/v, ideally from 0.1 to 5% w/v. The super wetting agents of this invention are silicone glycol copolymers and flurosurfactants.

The silicone glycol copolymers are described by the following formula:

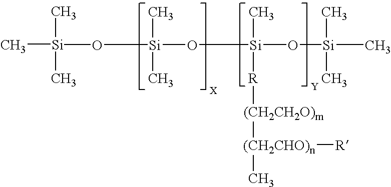

Where x, y, m and n are whole number ranging from 0 to 25. X is preferred between 0-10 and y, m and n between 0-5. R and R′ are straight chain or branched alkyl chain having from about 1 to about 25 carbon atoms, saturated or unsaturated, and the longest linear portion of the alkyl chain is 15 carbon atoms or less on the average. The fluorinated surfactant is described in the following formulae:
F(CF₂)ₙ—CH₂CH₂—S—CH₂CH₂—COOM
F(CF₂)ₙ—N(CH3)(CH2)3-(CH₂CH₂O)ₓOSO₂M
CF₃(CF₂CF₂)ₙ(CFCF)ₘ—(CH₂CH₂O)ₓ—OPO₃M₂

Wherein n, m and x are integers having a value from 0 to 15; preferred values are between 1 and 12. M is a cation which makes the compound water-soluble especially an alkali metal such as sodium or magnesium, ammonium or substituted ammonium cation.

The super wetting agents described are able to low the surface tension in water at values below 25 mN/m, in the range between 18 and 25 mN/m at working condition concentrations of 0.0001 to 1% w/v, preferably between 0.001 to 0.1% w/v.

The composition of the present invention may also contain one or more hydrotropes. Examples of suitable hydrotropes are sodium cumene sulfonate (ELTESOL SC40 available from Albright & Wilson), sodium xylene sulfonate (ELTESOL SX40 available from Albright & Wilson), di-sodium mono- and di-alkyl disulfonate diphenyloxide (DOWFAX 3B2 available from Dow Chemicals), n-octane sodium sulfonate (BIOTERGE PAS 7 S or 8 S available from Stepan). Levels of hydrotope added are from 0.01% to 15% w/v.

Organic solvents may be added and may be beneficial in term of improving the solubility of the cationic compounds in water. The organic solvents should be water-miscible. Preferably the organic solvent is found at levels of 0.001 to 15% w/v ideally 0.01 to 15% w/v or 0.5 to 5% w/v. The organic solvent constituent of the inventive compositions include one or more alcohols, glycols, acetates, ether acetates and glycol ethers. Exemplary alcohols useful in the compositions of the invention include C2-C8 primary and secondary alcohols which may be straight chained or branched. Exemplary alcohols include pentanol and hexanol. Exemplary glycol ethers include those glycol ethers having the general structure Ra—O—Rb—OH, wherein Ra is an alkoxy of 1 to 20 carbon atoms, or aryloxy of at least 6 carbon atoms, and Rb is an ether condensate of propylene glycol and/or ethylene glycol having from 1 to 10 glycol monomer units. Preferred are glycol ethers having 1 to 5 glycol monomer units.

By way of further non-limiting example specific organic constituents include propylene glycol methyl ether, dipropylene glycol methyl ether, tripropylene glycol methyl ether, propylene glycol n-propyl ether, ethylene glycol n-butyl ether, diethylene glycol n-butyl ether, diethylene glycol methyl ether, propylene glycol, ethylene glycol, isopropanol, ethanol, methanol, diethylene glycol monoethyl ether acetate and particularly useful is, propylene glycol phenyl ether, ethylene glycol hexyl ether, diethylene glycol hexyl ether.

The chelating agent is added at a level between 0.01 to 5% w/v, preferably between 0.1 to 1% w/v. Examples of chelating agents are described below:
the parent acids of the monomeric or oligomeric polycarboxylate chelating agents or mixtures therefore with their salts, e.g. citric acid or citrate/citric acid mixtures are also contemplated as useful builder components.
borate builders, as well as builders containing borate-forming materials than can produce borate under detergent storage or wash conditions can also be.
iminosuccinic acid metal salts
polyaspartic acid metal salts.
examples of bicarbonate and carbonate builders are the alkaline earth and the alkali metal carbonates, including sodium carbonate and sesqui-carbonate and mixtures thereof. Other examples of carbonate type builders are the metal carboxy glycine and metal glycine carbonate.
ethylene diamino tetra acetic acid and salt forms.
water-soluble phosphonate and phosphate builders are useful for this invention.

Examples of phosphate builders are the alkali metal tripolyphosphates, sodium potassium and ammonium pyrophosphate, sodium and potassium and ammonium pyrophosphate, sodium and potassium orthophosphate sodium polymeta/phosphate in which the degree of polymerisation ranges from 6 to 21, and salts of phytic acid. Specific examples of water-soluble phosphate builders are the alkali metal tripolyphosphates, sodium potassium and ammonium pyrophosphate, sodium and potassium and ammonium pyrophosphate, sodium and potassium orthophosphate, sodium polymeta/phosphate in which the degree of polymerisation ranges from 6 to 21, and salts of phytic acid.

The polymers used in this invention at a level between 0.01 to 30% w/v, preferably between 0.1 to 5% w/v. Examples of polymers are: water-soluble compounds include the water soluble monomeric polycarboxylates, or their acid forms, homo or copolymeric polycarboxylic acids or their salts in which the polycarboxylic acid comprises at least two caroxylic radicals separated from each other by not more than two carbon atoms, carbonates, bicarbonates, borates, phosphates, and mixtures of any of thereof. The carboxylate or polycarboxylate builder can be monomeric or oligomeric in type although monomeric polycarboxylates are generally preferred for reasons of cost and performance. Suitable carboxylates containing one carboxy group include the water soluble salts of lactic acid, glycolic acid and ether derivatives thereof. Polycarboxylates containing two carboxy groups include the water-soluble salts of succinic acid, malonic acid, (ethylenedioxy) diacetic acid, maleic acid, diglycolic acid, tartaric acid, tartronic acid and fumaric acid, as well as the ether carboxylates and the sulfinyl carboxylates. Polycarboxylates containing three carboxy groups include, in particular, water-soluble citrates, aconitrates and citraconates as well as succinate derivates such as the carboxymethloxysuccinates described in GB-A-1,379,241, lactoxysuccinates described in GB-A-1,389,732, and aminosuccinates described in NL-A-7205873, and the oxypolycarboxylate materials such as 2-oxa-1,1,3-propane tricarboxylates described in GB-A-1,387,447.

Polycarboxylate containing four carboxy groups include oxydisuccinates disclosed in GB-A-1,261,829, 1,1,2,2-ethane tetracarboxylates, 1,1,3,3-propane tetracarboxylates and 1,1,2,3-propane tetracarobyxlates. Polycarboxylates contining sulfo substituents include the sulfosuccinate derivatives disclosed in GB-A-1,398,421, GB-A-1,398,422 and U.S. Pat. No. 3,936,448, and the sulfonated pyrolsed citrates described in GB-A-1,439,000.

Alicylic and heterocyclic polycarboxylates include cyclopentane-cis,cis,cis-tetracarboxylates, cyclopentadienide pentacarboxylates, 2,3,4,5,6-hexane—hexacarboxylates and carboxymethyl derivates of polyhydric alcohols such as sorbitol, mannitol and xylitol. Aromatic polycarboxylates include mellitic acid, pyromellitic acid and the phthalic acid derivatives disclosed in GB-A-1,425,343.

Of the above, the preferred polycarboxylates are hydroxycarboxylates containing up to three carboxy groups per molecule, more particularly citrates.

More preferred polymers are homo-polymers, copolymers and multiple polymers of acrylic, fluorinated acrylic, sulfonated styrene, maleic anhydride, metacrylic, iso-butylene, styrene and ester monomers.

Examples of these polymers are Acusol supplied from Rohm & Haas, Syntran supplied from Interpolymer and Versa and Alcosperse series supplied from Alco Chemical, a National Starch & Chemical Company.

Antifoaming agents are critical for machine shampoo products: they are used in this invention at a level between 0.01 to 5% w/v. The foam level in fact doesn't allow to properly use the carpet cleaning machines if it is too high and in any case tends to reduce the mechanical action of the carpet cleaner machine brushes, having an impact on soil removal. Atifoaming agents are so considered important actives of this invention.

Examples are polydimethylsiloxanes in combination with hydrophobic silica in different ratios.

Water is present in the compositions at levels of up to 98% w/v, ideally up to 90% w/v.

Up to 10% w/v, ideally 8%, 5%, 4% or 2% w/v of additional minor ingredients can be added, selected from one or more of the following; perfumes, dyes, preservatives and antifoaming agents.

Points of advantage found in this invention:
The cationic compounds of the invention are compatible with anionic surfactants and other anionic species such as anionic polymers.
The cationic compounds of the invention, even if complexed provide a bactericidal action similar to uncomplexed cationic species.
The cationic compounds in fabric cleaning compositions don't cause any reduction in terms of cleaning performance, fabric damage and anti-re-deposition.
The cationic compounds can be combined with small amount of other bactericidal actives, such as essential oils, phenols, alcohols and acids, improving the bactericidal effect without lowering cleaning performance.

These cationic compounds can be used in liquid and powder carpet cleaning compositions. Examples of liquid compositions are ready to use products as triggers and dilutable products as manual and machine shampoos.

These cationic complexes are not very soluble in water, but this point can be easily overcome by combining them with anionic and non-ionic surfactants, by using solvents, hydrotropes and polymers. Heating the liquid compositions up to 60-80° C. can also help to improve the dissolution during manufacture.

A further feature of the invention is the use of a bactericidally active water-soluble cationic compound in its salt form, wherein the counterion anion has at least one of the following properties:
1) can generate a water-insoluble salt form, by water-insoluble we mean that less than 10% w/v dissolves in deionised water at 20° C., preferably less than 1% w/v;
2) has a MW of less than 300, preferably less than 200 but greater than 50, preferably greater than 75°;
3) the dissociation constant (Kd) of the salt is less than 10⁻³, preferably less than 10⁻⁶;
   as a bactericidally active component of a fabric treatment composition comprising from 0.001 to 40% w/v of an anionic surfactant.
   Tests

Several tests have been considered in this invention to evaluate the compatibility of the cationic complexes in anionic carpet cleaning compositions (Storage stability test), the bactericidal efficacy of the cationic complexes (AOAC Germicidal and Detergent Sanitizing Action of Disinfectants method), the cleaning performances (Stain removal test), the anti re-deposition and the carpet damage.

The cleaning performances have been compared with Resolve spot & stain carpet cleaner trigger and with Resolve pet stain & odour carpet cleaner trigger.

Storage Stability Test:

The 100 ml of the liquid compositions were put in to glass jars at 5, 25 and 40° C. The formula appearance and pH variation are considered and a rating assigned. The storage situation is monitored after 1 month and 3 months and compared with the starting values. The data table with the corresponding storage rating is reported below:

| Storage rating | | |
|---|---|---|
| (SR) | pH variation | Liquid appearance |
| 0 | 0 | No difference from reference |
| 1 | Less than 0.25 | No difference from reference |
| 2 | From 0.25 to 0.50 | No difference from reference |
| 3 | From 0.5 to 1 | No difference from reference |
| 4 | More than 1 | No difference from reference |
| 5 | From 0.25 to 0.50 | Separation and/or colour change |
| 6 | From 0.25 to 0.5 | Separation and/or colour change |
| 7 | From 0.5 to 1 | Separation and/or colour change |
| 8 | More than 1 | Separation and/or colour change |

The higher the rating number, the worse the storage performance. The anionic species found compatible with the cationic complexes are also reported.

Bactericidal Efficacy Test:

The AOAC Germicidal and Detergent Sanitizing Action of Disinfectants method has been used for bactericidal efficacy evaluation.

The efficacy has been tested against Staphylococcus aureus (ATCC 6538) and Enterbacter aerogenes (ATCC13048) and it is expressed as percentage bacteria reduction.

Stain Removal Test:

This method has been designed for the evaluation of stain removal performance of carpet cleaner compositions and especially of trigger products. The Resolve™ spot % stain carpet cleaner trigger and Resolve™ pet stain & odour carpet cleaner trigger has been used as a reference for spot removal products.

The stains were applied to nylon carpets following the procedures below:
Dirty Motor Oil
   0.1 grams sprayed with an airbrush using a 5 cm diameter template. Allow any sediment to settle and decant oil into a clean container.
Ink
   0.1 grams sprayed with an airbrush using a 5 cm diameter template—Blue oily ink (Pelikan).
Grape juice
   1.5 gram sprayed with an airbrush using a 5 cm diameter template—Welch's
Mud
   1.1 grams diluted 1:4 with water, well mixed and applied with a spatula into a loom with 3 cm diameter—green mud argital.
   5 cm diameter template—7 Lipton yellow teabags are put in 200 grams boiling water.
Coffee
   1 gram sprayed with an airbrush using a 5 cm diameter template—milk (3 ml) & sugar (20 g)
Spaghetti sauce
   0.75 grams applied with a spatula into a loom with 3 cm diameter—Ragù traditional.

The stains were allowed to set for 24 hours before cleaning. The cleaning process was carried out by spraying 4 grams of the product onto the stain, leaving it for 3 minutes and doing 10 strokes in the vertical and then in the horizontal direction using a clean cloth. The area is then blotted twice and left to dry for 24 hours.

A panel test has been done on stained and cleaned carpet swatches to check the stain removal from carpet pile. The panellists are provided with a new carpet as a 1 reference and a stained carpet as a reference of 5. The panellists assigned a value to the cleaned carpet swatches between 1 and 5. The lower the rating number, the better the cleaning performance. The rating number obtained from carpet pile and backing per stain/product is averaged.

Carpet Damage Test:

Multiple (×3) cleaning process steps were done on a blue nylon carpet and red wool carpet to check for any potential damage of the compositions of this invention to the carpet fibre or colour. Resolve™ trigger spot & stain carpet cleaner was used as a reference product.

A panel test is used for evaluating carpet damage. Panellists are given a non-cleaned carpet swatch as a control of 0 per each carpet type/colour. The evaluation scale ranges from 0 to 4, 0 is no colour change, 4 corresponds to very high colour change.

The responses of the panellist are averaged.

| Damage rating (DR) | Carpet damage description |
|---|---|
| 0 | No colour change or fibre damage |
| 1 | Slight colour change and fibre damage |
| 2 | Perceptible colour change and fibre damage |
| 3 | Evident colour change and fibre damage |
| 4 | Strong colour change and fibre damage |

An accepted carpet damage rating is parity or below 1.

Anti Re-Deposition Test:

This method has been designed for the evaluation of anti re-deposition product evaluation.

The soil used has the following composition:

| Soil components: | % by weight |
|---|---|
| Peat Moss | 47.7 |
| Cement | 21.4 |
| Kaolin clay | 8.0 |
| Silica | 8.0 |
| Red Iron oxide | 1.3 |
| Charcoal | 12.6 |
| Mineral oil | 1.0 |

A nylon carpet is used for the test.

A cleaning process is carried out by spraying 4 grams of the product onto the carpet, leaving it for 3 minutes and doing 10 strokes in the vertical and then in the horizontal direction using a clean cloth. The area is then blotted twice and left to dry for 24 hours.

The carpet is soiled with 5 grams of standard soil. The soil is applied 1 gram once by strainer. The soiled carpet is then put with 4 kg of steel beads in the jar mill and stirred for 30 minutes at 56 rpm.

Carpet swatches are placed in a dark room temperature chamber (25° C./50% RH) for 24 hours while they dry.

The carpet swatches are the vacuumed doing 3 strokes in the vertical and then in the horizontal direction.

The water is used as a ‘product’ reference for having no positive or negative impact on anti re-deposition.

The anti re-deposition performance is evaluated by measuring the carpet with a portable spectrophotometer before cleaning after soiling and vacuuming. The result is reported as anti re-deposition percentage, where a positive value indicates an anti re-deposition effect and a negative value indicates a product stickness.

### EXAMPLES

The liquid compositions are typically prepared by mixing each ingredient together in a suitable container.

Examples of compositions forming a part of the present invention related to ready to use products are set below in Tab 1 and 2, examples for dilutable machine carpet cleaner liquids are reported in table 3 and examples for dilutable manual shampoo liquids with are described in table 4. All the various components are identified in Tab 5.

TABLE 1

| | Ex 1 | Ex 2 | Ex 3 | Ex 4 | Ex 5 |
|---|---|---|---|---|---|
| Components | % | % | % | % | % |
| Trilon B | 11.20 | 11.20 | 11.20 | 1.00 | 1.00 |
| Trilon BS acid | 2.00 | 1.40 | 2.00 | | |
| Citric acid | | | | 0.11 | 0.08 |
| Stepanol WAC | 3.00 | 3.00 | 3.00 | 3.00 | 3.00 |
| Syntran 1575 | 3.00 | 3.00 | 3.00 | | |
| Zelan 338 | | | | 0.15 | 0.15 |
| Genapol 26-L-5 | 0.50 | 0.50 | 0.50 | | |
| Zonyl 7950 | | | | 0.15 | 0.15 |
| Onyxide 3300 33% | 0.50 | 0.30 | 0.30 | 0.35 | 0.35 |
| Kathon CG/ICP | 0.10 | 0.10 | 0.10 | 0.05 | 0.05 |
| Thymol Kristal | 0.09 | 0.09 | 0.09 | 0.09 | 0.09 |
| powder | | | | | |
| Dowanol PPH | | 1.50 | 1.50 | 1.50 | 1.50 |
| Isopropyl alcohol | | | | 2.00 | 2.00 |
| Soft water | 79.61 | 78.91 | 78.31 | 91.65 | 91.68 |
| pH | 6.7 | 8.0 | 6.5 | 6.5 | 8.0 |

TABLE 2

| | Ex 6 | Ex 7 | Ex 8 | Ex 9 | Ex 10 |
|---|---|---|---|---|---|
| Components | % | % | % | % | % |
| Trilon B | 1.00 | 1.00 | 1.00 | 1.00 | 1.00 |
| Citric acid | 0.08 | 0.08 | 0.08 | 0.08 | 0.08 |
| Stepanol WAC | 3.00 | 3.00 | 3.00 | 3.00 | 3.00 |
| Zelan 338 | 0.15 | 0.15 | 0.15 | 0.15 | 0.15 |
| Zonyl 7950 | 0.15 | 0.15 | 0.15 | 0.15 | 0.15 |
| Onyxide 3300 33% | 0.20 | 0.50 | 0.20 | 0.35 | 0.50 |
| Kathon CG/ICP | 0.05 | 0.05 | 0.05 | 0.05 | 0.05 |
| Thymol Kristal | 0.09 | 0.09 | | | |
| powder | | | | | |
| Fragrance | | | 0.15 | 0.15 | 0.15 |
| Dowanol PPH | 1.50 | 1.50 | 1.50 | 1.50 | 1.50 |
| Isopropyl alcohol | 2.00 | 2.00 | 2.00 | 2.00 | 2.00 |
| Soft water | 91.78 | 91.48 | 91.72 | 91.57 | 91.42 |
| pH | 7.8 | 7.8 | 7.7 | 7.7 | 7.7 |

TABLE 3

| | Ex 11 | Ex 12 | Ex 13 |
|---|---|---|---|
| Components | % | % | % |
| Trilon B | 8.11 | 8.11 | 8.11 |
| Trilon BS acid | 0.77 | 0.77 | 0.77 |
| Sodium bicarbonate | 0.06 | 0.06 | 0.06 |
| Petro 11 liquid | 1.23 | 1.23 | 1.23 |
| Eltesol SC40 | 7.00 | 6.00 | 9.50 |
| Genapol 26-L-60 | 2.03 | 2.03 | 2.03 |
| Syntran 1580 | 1.59 | 1.59 | 1.59 |
| Onyxide 3300 | 1.90 | 1.90 | 1.90 |
| Silicone antifoam | 0.05 | 0.05 | 0.05 |
| Fragrance | 0.40 | 0.40 | 0.40 |
| Dowanol PPH | | | 1.00 |
| Dowanol DPnP | 1.90 | 2.85 | |
| Soft water | 74.96 | 75.01 | 73.362 |
| pH | 8.7 | 8.9 | 8.7 |

TABLE 4

| | Ex 14 | Ex 15 |
|---|---|---|
| Components | % | % |
| Dequest 2066 | 2.00 | 2.00 |
| Empicol 0335 | 19.00 | 19.00 |
| Syntran DX 302-1 | 12.50 | 12.50 |
| Onyxide 3300 33% | 1.40 | 2.80 |
| Fragrance | 0.25 | 0.25 |
| Dye | 0.0004 | 0.0004 |
| Soft water | 64.85 | 63.45 |
| pH | 6.9 | 6.9 |

TABLE 5

| Component | Description of component |
|---|---|
| Trilon B | EDTA tetrasodium salt 40% from BASF |
| Trilon BS acid | EDTA acid powder from BASF |
| Citric acid | Citric acid from various suppliers |
| Sodium bicarbonate | Sodium bicarbonate from various suppliers |
| Syntran 1575 | Fluorinated acrylic copolymer from Interpolymer |
| | Corporation |
| Syntran 1580 | Acrylic copolymer from Interpolymer Corporation |
| Syntran DX302-1 | Acrylic copolymer from Interpolymer Corporation |
| Onyxide 3300 33% | Miristalkonium saccharinate in alcohol from |
| | Stepan |
| Onyxide 3300 | Miristalkonium saccharinate from Stepan |
| Stepanol WAC | Sodium lauryl sulfate from Stepan |
| Empicol 0335 | Sodium alkyl sulfate from Hutsman |
| Petro 11 liquid | Sodium alkyl naphthalene sulfonate from Akzo |
| Eltesol SC40 | Sodium cumene sulfonate from Hutsman |
| Genapol 26-L-5 | Primary alcohol ethoxylate from Hoechst |
| | Celanese |
| Genapol 26-L-60 | Primary alcohol ethoxylate from Hoechst |
| | Celanese |
| Kathon CG/ICP | Isothiazolinone from Rohm & Haas |
| Thymol Krist powder | Thymol from H. Reimer |
| Zonyl 7950 | Fluorosurfactant from Dupont |
| Zelan 338 | Polycarboxylate from Dupont |
| Dowanol PPH | 1-phenoxy 2-propanol from Dow chem |
| Dowanol DPnP | Dipropylene glycol n-propyl ether from Dow |
| | chem |
| Isopropyl alcohol | Isopropyl alcohol |
| Fragrance | Proprietary fragrance from various suppliers |

Example Results:

The stain removal and carpet damage performances have been compared with Resolve spot & stain carpet cleaner trigger and with Resolve pet stain & odour carpet cleaner trigger, considered as two of the market leaders in US for stain removal products.

Results for Storage Stability Test:

In the table below are reported the storage rating values (SR) per each storage condition and the compatibility between onyxide 3300 and anionic species.

| | Stability test rating (ready to use product) | | | | | | |
|---|---|---|---|---|---|---|---|
| | 1 month | | | 3 months | | | Onyxide 3300 is |
| | SR | SR | SR | SR | SR | SR | compatible with the |
| Product | 5° C. | 25° C. | 40° C. | 5° C. | 25° C. | 40° C. | following anionics species: |
| Ex 1 | 2 | 1 | 1 | 2 | 1 | 1 | Stepanol WAC, |
| | | | | | | | Syntran 1575 |
| Ex 2 | 1 | 1 | 1 | 1 | 1 | 1 | Stepanol WAC, |
| | | | | | | | Syntran 1575 |
| Ex 3 | 0 | 1 | 1 | 1 | 1 | 3 | Stepanol WAC, |
| | | | | | | | Syntran 1575 |
| Ex 4 | 1 | 1 | 1 | 1 | 1 | 1 | Stepanol WAC, Zelan |
| | | | | | | | 338, Zonyl 7950 |
| Ex 5 | 0 | 1 | 1 | 1 | 1 | 5 | Stepanol WAC, Zelan |
| | | | | | | | 338, Zonyl 7950 |
| Ex 6 | 0 | 0 | 1 | 0 | 0 | 1 | Stepanol WAC, Zelan |
| | | | | | | | 338, Zonyl 7950 |
| Ex 7 | 0 | 0 | 2 | 5 | 2 | 6 | Stepanol WAC, Zelan |
| | | | | | | | 338, Zonyl 7950 |
| Ex 8 | 0 | 0 | 0 | 0 | 2 | 2 | Stepanol WAC, Zelan |
| | | | | | | | 338, Zonyl 7950 |
| Ex 9 | 0 | 0 | 0 | 0 | 0 | 2 | Stepanol WAC, Zelan |
| | | | | | | | 338, Zonyl 7950 |
| Ex 10 | 0 | 0 | 0 | 0 | 0 | 2 | Stepanol WAC, Zelan |
| | | | | | | | 338, Zonyl 7950 |

| | Stability test rating (dilutable product-manual and | | | |
|---|---|---|---|---|
| | machine shampoos) | | | |
| | 2 weeks | | | Onyxide 3300 is |
| | SR | SR | SR | compatible with the |
| Product | 5° C. | 25° C. | 40° C. | following anionics species: |
| Ex 13 | 0 | 0 | 0 | Eltesol SC40, Petro 11, |
| | | | | Syntran 1580 |
| Ex 14 | 0 | 0 | 0 | Empicol 0335, Syntran DX |
| | | | | 302-1 |
| Ex 15 | 0 | 0 | 0 | Empicol 0335, Syntran DX |
| | | | | 302-1 |

Results for Bactericidal Efficacy Test (Ready to Use Product):

| | Disinfectant efficacy | | | | | |
|---|---|---|---|---|---|---|
| | Staphylococcus aureus | | | Enterobacter aerogenes | | |
| | (bacteria reduction % with different contact times) | | | | | |
| | 30 sec | 1 min | 5 min | 30 sec | 1 min | 5 min |
| Reference: | 78.677 | 87.721 | 98.920 | 47.500 | 74.000 | 99.775 |
| Resolve spot & | | | | | | |
| Ex 5 | 99.442 | 99.943 | 99.999 | 99.999 | 99.999 | 99.999 |
| Ex 6 | 99.324 | 99.913 | 99.999 | 99.999 | 99.999 | 99.999 |
| Ex 7 | 99.331 | 99.924 | 99.999 | 99.999 | 99.999 | 99.999 |
| Ex 8 | 90.000 | 96.250 | 99.928 | 99.999 | 99.999 | 99.999 |
| Ex 9 | 89.118 | 96.986 | 99.952 | 99.999 | 99.999 | 99.999 |
| Ex 10 | 91.618 | 97.059 | 99.937 | 99.999 | 99.999 | 99.999 |

Results for Stain Removal Tests (Ready to Use Products):

It has been used Resolve™ Spot and stain trigger and pet stain & odour trigger products as a references. 3 replicates has been considered per each product and the values reported in the table below are averaged.

| | Stain removal rating | | | | | |
|---|---|---|---|---|---|---|
| | | | Grape | | Spaghetti | |
| | Mud | DMO | juice | Coffee | sauce | Ink |
| Resolve ™ Spot and | 3.7 | 3.3 | 3.0 | 3.1 | 3.2 | 4.2 |
| stain trigger | | | | | | |
| Resolve ™ pet stain & | 4.0 | 3.0 | 3.2 | 3.0 | 3.7 | 4.0 |
| odour trigger | | | | | | |
| Ex 1 | 4.2 | 3.2 | 2.7 | 3.2 | 4.0 | 3.9 |
| Ex 2 | 4.2 | 2.7 | 3.1 | 3.7 | 3.4 | 3.8 |
| Ex 3 | 4.3 | 2.7 | 3.2 | 3.7 | 3.0 | 3.9 |
| Ex 4 | 3.8 | 3.5 | 3.1 | 3.6 | 3.4 | 4.2 |
| Ex 5 | 3.4 | 3.0 | 3.2 | 3.6 | 3.1 | 3.8 |

Results for Carpet Damage Test and Anti Re-Deposition (Ready to Use Product):

It has been used again Resolve™ Spot and stain trigger and pet stain & odour trigger products as references. Per each product/carpet type has been considered 3 replicates and the values reported in the table below are averaged.

| | Damage test | | | | Anti re- |
|---|---|---|---|---|---|
| | Beige | Red | | Green | deposition |
| | wool | wool | Blue nylon | polyester | test |
| Product | rating | rating | rating | rating | % |
| Resolve ™ Spot and | 0.7 | 0.6 | 0.1 | 0.1 | 10.3 |
| stain trigger | | | | | |
| Ex 4 | 0.6 | 0.6 | 0.5 | 0.0 | 8.0 |
| Ex 5 | 1.0 | 0.8 | 0.2 | 0.0 | 2.5 |

1. A detergent comprising:
a) 0.001% to 40% w/v of a bactericidally active water-insoluble cationic compound in its salt form wherein the counterion anion has at least one of the following properties:
1) can generate a water-insoluble salt form wherein less than 10% w/v dissolves in deionised water at 20° C.;
2) has a MW of less than 300, but greater than 50,
3) the dissociation constant (Kd) of the salt form is less than 10⁻³;
b) 0.001 to 40% w/v of an anionic surfactant; and
c) up to 98% w/v of water.

2. A detergent composition as in claim 1 which additionally comprises 0.001 to 30% w/v of a non-ionic surfactant.

3. A detergent composition according to claim 1 which additionally comprises 0.001 to 10% w/v of a superwetting agent.

4. A detergent composition according to claim 3 wherein the super wetting agent is able to lower the surface tension of water to below 25 mN/m at concentrations of 0.0001 to 1% w/v.

5. A detergent composition according to claim 1 which additionally comprises 0.001% to 15% of a water-miscible organic solvent.

6. A detergent composition according to claim 1 which additionally comprises 0.01-5% w/v of a chelating agent, 0.01-30% w/v of a polymer and up to 2% w/v of minor ingredients selected from perfumes, dyes, preservatives and antifoaming agents

7. A detergent composition according to claim 1 which further comprises from 0.001 to 1% w/v of an additional bactericidally active product selected from essential oils (tea tree oil, citronella oil and thyme oil), phenols, alcohols, halogens, aldehydes and acids.

8. A detergent composition according to claim 1 wherein the cationic compound is 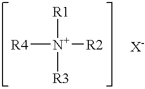
wherein R1, R2, R3 and R4 are independently selected from alkyl, aryl or alkylaryl substituent of from 1 to 26 carbon atoms straight chained or branched and may include one or more amide, ether or ester linkates, and the entire cation portion of the molecule has a molecular weight of at least 165 and X is the counterion anion.

9. A detergent composition according to claim 8 wherein the cationic compound is 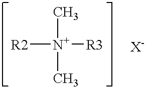
wherein R2 and R3 are each independently the same or different C8-C12 alkyl; or R2 is selected from C12-16 alkyl, C8-18 alkylethoxy or C8-18 alkylphenoxyethoxy and R3 is benzyl and X is the counterion anion.

10. A detergent composition according to claim 7 wherein X⁻ is selected from saccharinate, alkyl and alkyl benzene sulfate, sulfonate and fatty acid.

11. Use of a bactericidally active water-insoluble cationic compound in its salt form, wherein the counterion anion has at least one of the following properties:
1) can generate a water-insoluble salt form wherein less than 10% w/v dissolves in deionised water at 20° C.;
2) has a MW of less than 300 but greater than 50;
3) the dissociation constant (Kd) of the salt form is less than 10⁻³;
as a bactericidally active component of a fabric treatment composition comprising from 0.001 to 40% w/v of an anionic surfactant.
